(19) United States
(12) Patent Application Publication
(10) Pub. No.: US 2016/0014281 A1
(43) Pub. Date: Jan. 14, 2016

(54) CONTACT INFORMATION TRANSFER SYSTEM, CONTACT INFORMATION TRANSFER METHOD, PORTABLE TERMINAL APPARATUS, AND RECORDING MEDIUM

(71) Applicant: Konica Minolta, Inc., Tokyo (JP)

(72) Inventors: Shohei Ichiyama, Toyokawa-shi (JP); Hiroaki Sugimoto, Nagoya-shi (JP); Yoichi Kurumasa, Toyokawa-shi (JP); Yusuke Shinosaki, Toyokawa-shi (JP); Mie Kawabata, Toyokawa-shi (JP)

(73) Assignee: Konica Minolta, Inc., Tokyo (JP)

(21) Appl. No.: 14/796,136

(22) Filed: Jul. 10, 2015

(30) Foreign Application Priority Data
Jul. 11, 2014 (JP) 2014-143711

(51) Int. Cl. H04N 1/00

(52) U.S. Cl. CPC H04N 1/00106; H04N 1/00122

(57) ABSTRACT

A contact information transfer system includes an image processing apparatus and a portable terminal apparatus; the portable terminal apparatus includes a cooperation portion that launches a second application for organizing contact information upon access to the image processing apparatus being enabled by a first application for accessing the image processing apparatus, the contact information including contact identification information and points of contact connected to the respective contact identification information, a contact information obtaining portion that obtains the contact information, and a transfer portion that transfers the contact information to the image processing apparatus; the image processing apparatus includes a receiving portion that receives the contact information, a display, and a display controller that displays the contact information on the display by converting it into a data format supported on the display.

This application claims priority under 35 U.S.C. §119 to Japanese Patent Application No. 2014-143711 filed on Jul. 11, 2014, the entire disclosure of which is incorporated herein by reference in its entirety.

### BACKGROUND OF THE INVENTION

1. Field of the Invention

The present invention relates to an image processing apparatus such as a multifunctional digital image forming apparatus (i.e., a multi-function peripheral abbreviated as MFP) having printer function, facsimile function, scanner function, and other functions, a contact information transfer system having a portable terminal apparatus such as a smartphone or a tablet computer terminal, a contact information transfer method to be implemented by the contact information transfer system, the portable terminal apparatus, and a non-transitory computer-readable recording medium.

2. Description of the Related Art

The following description sets forth the inventor's knowledge of related art and problems therein and should not be construed as an admission of knowledge in the prior art.

In recent years, there are network systems having an image processing apparatus as mentioned above and portable terminal apparatuses having applications being installed for accessing this image processing apparatus and these network systems allow users to manipulate the image processing apparatus from their portable terminal apparatuses and to instruct the image processing apparatus to perform processing on data stored on their portable terminal apparatuses.

With such a network system, users may need to transfer contact information to the image processing apparatus from their portable terminal apparatuses. In order to achieve this, there are conventional and well-known techniques; these are a series of developing an exclusive application, installing this application on portable terminal apparatuses, enabling access between the portable terminal apparatuses and the image processing apparatus, and allowing the users to select contact information and transfer the contact information to the image processing apparatus by manipulating their portable terminal apparatuses with a gesture or other activation.

For example, as introduced by Japanese Unexamined Patent Publication No. 2009-177626, it is a system that allows users to transfer address information and attached information (information attached to emails or facsimiles) to an image processing apparatus by manipulating their portable terminal apparatuses having applications for controlling the image processing apparatus.

Unfortunately, with conventional techniques as described above, users are bothered by selecting contact information and giving transfer instructions on an exclusive application that is developed for transferring contact information to the image processing apparatus.

Specifically, users are bothered by making a selection and giving transfer instructions on their portable terminal apparatuses then operating the image processing apparatus to check contact information displayed on its operation panel, meanwhile they have to keep switching their views on between their portable terminal apparatuses and the image processing apparatus back and forth. That is not simple manipulation and not a user-friendly system.

More specifically, users are bothered by doing the following manipulation about every selection they make: selecting a desirable contact target; giving instructions to transfer contact information to the image processing apparatus; and checking its operation panel to confirm the safe receipt of the contact information.

### SUMMARY OF THE INVENTION

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

A first aspect of the present invention relates to a contact information transfer system comprising an image processing apparatus and a portable terminal apparatus, the image processing apparatus and the portable terminal apparatus being capable of accessing each other, the portable terminal apparatus including:

a cooperation portion that launches a second application for organizing contact information upon access to the image processing apparatus being enabled by a first application for accessing the image processing apparatus, the contact information including a plurality of contact identification information for identifying the contact and points of contact, the points of contact being connected to the respective contact identification information;

a contact information obtaining portion that obtains the contact information as instructed by the first application, after the launch of the second application; and

a transfer portion that transfers the contact information to the image processing apparatus as instructed by the first application, the contact information being obtained by the contact information obtaining portion,

the image processing apparatus comprising:

a receiving portion that receives the contact information from the portable terminal apparatus;

a display; and

a display controller that displays the contact information on the display by converting the contact information into a data format supported on the display, the contact information being received by the receiving portion.

A second aspect of the present invention relates to a contact information transfer method to be implemented by a contact information transfer system comprising an image processing apparatus and a portable terminal apparatus, the image processing apparatus and the portable terminal apparatus being capable of accessing each other, the contact information transfer method including the steps of the portable terminal apparatus:

launching a second application for organizing contact information upon access to the image processing apparatus being enabled by a first application for accessing the image processing apparatus, the contact information including a plurality of contact identification information for identifying the contact and points of contact, the points of contact being connected to the respective contact identification information;

obtaining the contact information as instructed by the first application, after the launch of the second application; and

transferring the contact information to the image processing apparatus as instructed by the first application, the contact information being obtained also as instructed by the first application,

the contact information transfer method further including the steps of the image processing apparatus:

receiving the contact information from the portable terminal apparatus; and

displaying the contact information on the display by converting the contact information into a data format supported on the display, the contact information being received from the portable terminal apparatus.

A third aspect of the present invention relates to a portable terminal apparatus including:

a cooperation portion that launches a second application for organizing contact information upon access to the image processing apparatus being enabled by a first application for accessing the image processing apparatus, the contact information including a plurality of contact identification information for identifying the contact and points of contact, the points of contact being connected to the respective contact identification information;

a contact information obtaining portion that obtains the contact information as instructed by the first application, after the launch of the second application; and

a transfer portion that transfers the contact information to the image processing apparatus as instructed by the first application, the contact information being obtained by the contact information obtaining portion.

A fourth aspect of the present invention relates to a non-transitory computer-readable recording medium storing a contact information transfer program for a computer of a portable terminal apparatus, the contact information transfer program making the computer execute:

launching a second application for organizing contact information upon access to an image processing apparatus being enabled by a first application for accessing the image processing apparatus, the contact information including a plurality of contact identification information for identifying the contact and points of contact, the points of contact being connected to the respective contact identification information;

obtaining the contact information as instructed by the first application, after the launch of the second application; and

transferring the contact information to the image processing apparatus as instructed by the first application, the contact information being obtained also as instructed by the first application.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying drawings, in which:

FIG. 1 illustrates a configuration of a contact information transfer system according to one embodiment of the present invention.

FIG. 2 is a block diagram illustrating a configuration of a portable terminal apparatus.

FIG. 3 is a block diagram illustrating a configuration of main parts of an image processing apparatus.

FIG. 4 is a block diagram illustrating functional configurations of a controller of the portable terminal apparatus and a main body system controller of the image processing apparatus.

FIG. 5A is a schematic view of a home screen to be displayed on the portable terminal apparatus; FIG. 5B illustrates a screen to which the screen switches when a user starts up an address book application; FIG. 5C illustrates a screen to which the screen switches when a MFP-terminal access application is launched.

FIG. 6A illustrates that a user is selecting a desirable contact name from those displayed in a list form on the portable terminal apparatus; FIG. 6B illustrates a screen having detailed contact information of the selected contact name.

FIG. 7A illustrates that a user is starting up the address book application while the MFP-terminal access application is open; FIG. 7B illustrates a screen having all contact names to be displayed in a list when the address book application is launched; FIG. 7C illustrates a screen to be displayed when the user selects a desirable contact name from the list.

FIGS. 8A to 8F illustrate a contact information transfer process to be performed by the portable terminal apparatus and the image processing apparatus when intent is enabled.

FIG. 9 illustrates a procedure of how the MFP-terminal access application launches the address book application to obtain contact information.

FIG. 10 illustrates a detailed procedure of how the MFP-terminal access application obtains contact information.

FIG. 11 illustrates another procedure of how the MFP-terminal access application obtains contact information.

FIG. 12 is a flowchart representing an operation procedure of the portable terminal apparatus.

FIG. 13 is a flowchart representing an operation procedure of the image processing apparatus.

FIG. 14 is a flowchart representing an operation procedure to be executed by the image processing apparatus and the portable terminal apparatus when a user selects a contact name from those displayed in a list form on a display of the image processing apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, some embodiments of the present invention will be described with reference to the accompanying drawings.

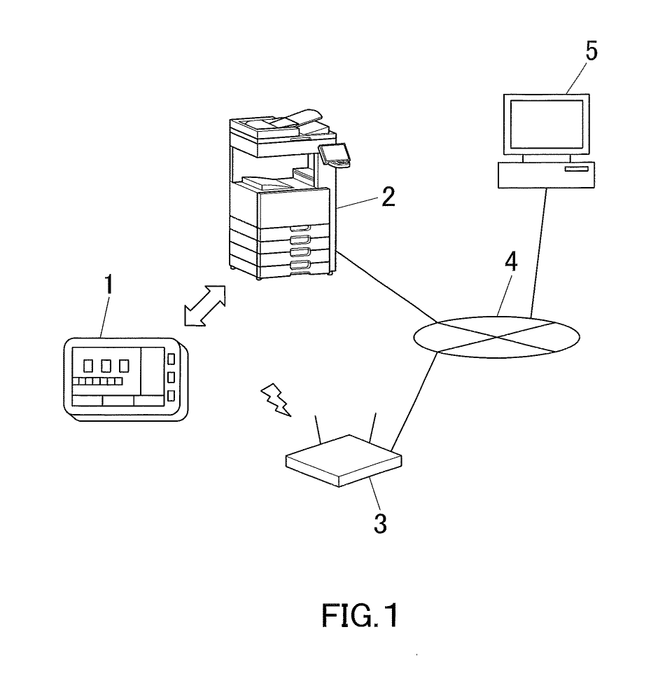

FIG. 1 illustrates a configuration of a contact information transfer system according to one embodiment of the present invention.

The contact information transfer system is provided with a portable terminal apparatus 1 such as a smartphone or a tablet computer terminal and an image processing apparatus 2; the portable terminal apparatus 1 and the image processing apparatus 2 are mutually connected via a wireless LAN router 3 and a network 4 such that they are capable of accessing each other. Alternatively, the portable terminal apparatus 1 and the image processing apparatus 2 may be mutually connected through short distance wireless communication. A personal computer 5 is connected to the network 4.

In this embodiment, a MFP, having various functions such as copier function, printer function, scanner function, and facsimile function as described above, is employed as the image processing apparatus 2. Hereinafter, the image processing apparatus will also be referred to as “MFP”. The portable terminal apparatus will also be referred to as “portable terminal” or more simply, “terminal”.

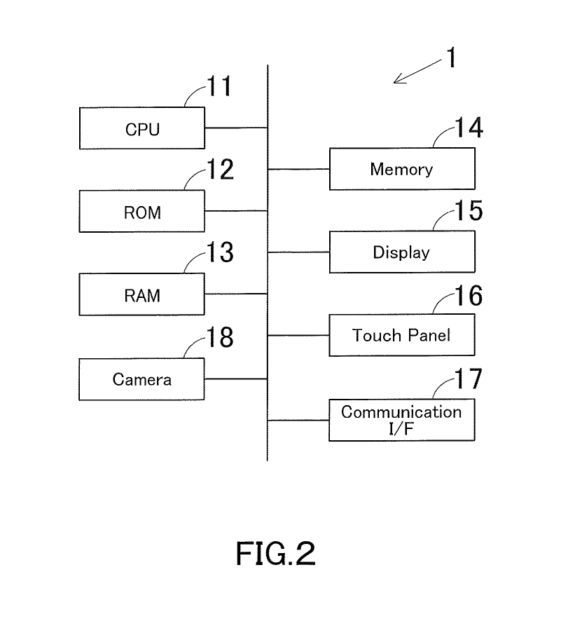

FIG. 2 is a block diagram illustrating a configuration of the portable terminal 1.

The portable terminal 1 is provided with a CPU 11, a ROM 12, a RAM 13, a memory 14, a display 15, a touch panel 16, a communication interface (communication IF) 17, a camera 18, and other portions.

The CPU 11 controls the portable terminal 1 in a unified and systematic manner as instructed by an operating system (abbreviated as OS), an application for accessing the MFP 2 (also referred to as “app”, simply), an address book app that functions as an address book for organizing contact information registered by a user, and other various apps. The control operations will be later described in details.

The ROM 12 is a memory that stores operation programs for the CPU 11 and other data; the RAM 13 is a memory that provides a work area for the CPU 11 to execute the operation programs.

The memory 14 is a memory that stores the OS, the apps, contact information, and other data.

The display 15 displays operation screens, messages, and other output for user manipulation, as well as various images such as web pages and pictures taken by a camera; the display 15 is comprised of a liquid-crystal display device, for example. The touch panel 16, being provided on the surface of the display 15, detects a user's touches including gestures and identifies the coordinates at which the user touches.

The communication interface 17 supports telephone calls over a telephone circuit and supports wireless data communications with the MFP 2 and other external apparatuses through an access point. The camera 18 serves to take pictures of various objects.

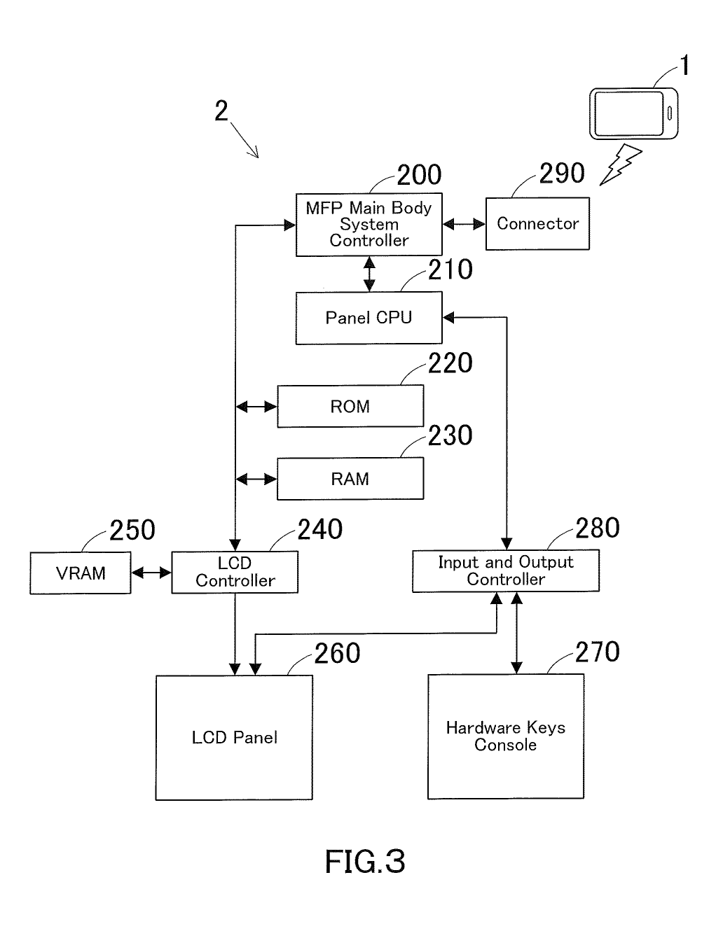

FIG. 3 is a block diagram illustrating a configuration of main parts of the MFP 2. As illustrated in FIG. 3, the MFP 2 is provided with a MFP main body system controller 200, a panel CPU 210, a ROM 220, a RAM 230, a LCD controller 240, a VRAM 250, a LCD panel 260, a hardware keys console 270, an input and output controller 280, and a connector 290.

The MFP main body system controller 200 controls the MFP 2 in a unified and systematic manner; the MFP main body system controller 200 implements various functions such as copier function, printer function, facsimile function, and scanner function as instructed by a user.

The panel CPU 210 controls the manipulation system in a unified manner, while communicating with the MFP main body system controller 200. The ROM 220 stores operation programs for the panel CPU 210, image data including screen data of screens to be displayed on the LCD panel 260, and other data. The RAM 230 provides a work area for the panel CPU 210 to perform processing as instructed by the operation programs stored on the ROM 220.

The LCD controller 240 controls the read and write operations of the VRAM 250 and the display operation of the LCD panel 260. Specifically, the LDC controller 240 obtains images from the ROM 220 to write in the VRAM 250 as instructed by the panel CPU 210 then retrieve them from the VRAM 250 to display on the LCD panel 260.

The LCD panel 260 is comprised of a liquid-crystal display (LCD) device having touch panel functionality and displays various screens, messages, and other information.

The hardware keys console 270 is comprised of the following portions: a hardware keyboard having a start key a numeric keypad, a panel reset key, and other keys; a LED indicating the status of the MFP 2; a beeper that emits beep tones confirming that the hardware keyboard or the LCD panel 260 accepts input and output manipulations; and other portions.

The input and output controller 280 detects a user physically touching on the LCD panel 260, judges the touch position, transfers to the panel CPU 210 a notification of a function option selected from those displayed on the screen, and controls the input and output operations in accordance with the function and other settings. Furthermore, by controlling the hardware keys console 270, the input and output controller 280 communicates with the MFP main body system controller 200 through the intermediation of the panel CPU 210 as the need arises.

It should be noted that, upon the pressing on a start key of the hardware keys console 270, this notification is transferred to the input and output controller 280 and also transferred to the MFP main body system controller 200 through the intermediation of the panel CPU 210; in this way, the MFP 2 is allowed to start a series of copier operations.

The connector 290 is an interface for connecting to the portable terminal 1. This allows the MFP 2 to perform interactive data communications with the portable terminal 1 by accessing the portable terminal 1.

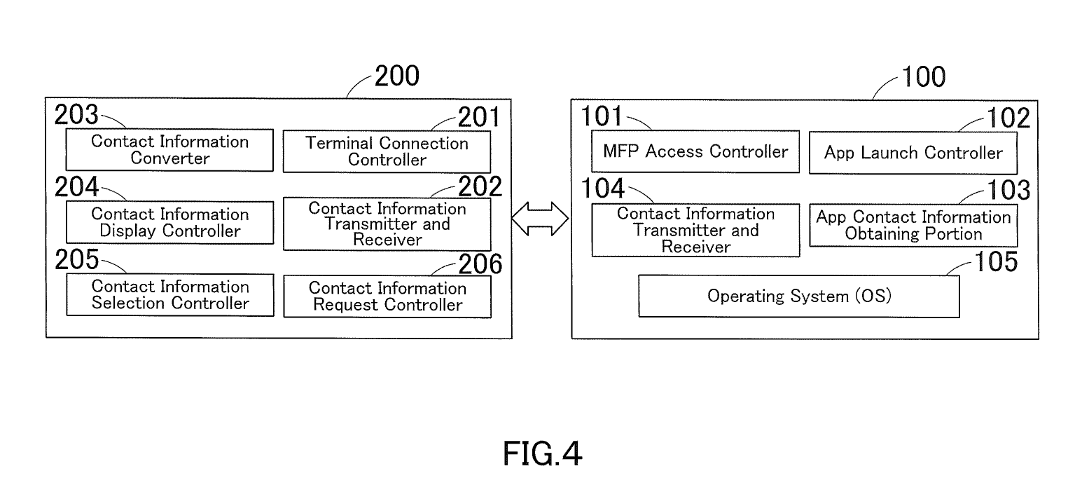

FIG. 4 is a block diagram illustrating functional configurations of the controller of the portable terminal 1 and the main body system controller 200 of the MFP 2.

The portable terminal 1 is provided with the following functional portions: a MFP access controller 101, an app launch controller 102, an app contact information obtaining portion 103, and a contact information transmitter and receiver 104. The functions of these portions are implemented by the CPU 11 of the portable terminal 1 as instructed by a MFP-terminal access app for accessing the MFP 2 (will be also referred to as “access app”, simply) and an OS 105 installed on the portable terminal 1.

The MFP access controller 101 enables access between the portable terminal 1 and the MFP 2 by specifying an IP address of the MFP 2. The app launch controller 102 launches a general-purpose app when access is enabled between the portable terminal 1 and the MFP 2. Here, it should be noted that there is a cooperation function called “intent” which enables access to a function of an app by launching this app from another app. In this embodiment, intent enables accessing a function of an address book app for organizing contact information, by launching this address book app from another app.

The app contact information obtaining portion 103 obtains contact information organized by the address book app, while the address book app is open. In this way, the address book app is launched by intent and finally obtains contact information organized by the address book app itself. Here, it should be noted that contact information includes contact names as contact IDs and it also includes points of contact connected to a specified contact name, for example: telephone number, facsimile number, and email address.

The contact information transmitter and receiver 104 transfers to the MFP 2 the contact information obtained from the address book app.

The connection between the portable terminals 1 and the MFP 2, intent, obtaining contact information, and transferring the contact information to the MFP 2 are performed with an application program interface (API) supplied by the OS 105.

The MFP main body system controller 200 is provided with the following functional portions: a terminal connection controller 201, a contact information transmitter and receiver 202, a contact information converter 203, a contact information display controller 204, a contact name selection controller 205, and a contact information request controller 206.

The terminal connection controller 201 allows the MFP 2 to connect to the portable terminal 1 by controlling the connector 290; the contact information transmitter and receiver 202 receives contact information from the portable terminal 1 and transfers a request for points of contact, which is generated by the contact information request controller 206, to the portable terminal 1.

After the contact information transmitter and receiver 202 receives the contact information, the contact information converter 203 converts the contact information into a raster image format or a font format so that the contact information can be displayed on the LCD panel 260. The contact information display controller 204 controls operations such that the contact information converted by the contact information converter 203 will be displayed on the LCD panel 260. In this embodiment, the contact information includes a plurality of contact names as contact identification information for identifying the contact and points of contact connected to the respective contact name.

While a list of contact names is displayed on the LCD panel 260, the contact name selection controller 205 specifies a contact name selected by a user from the list and records on a memory the selected contact name and points of contact connected to that contact name.

After the contact name selection controller 205 specifies the contact name selected by the user, the contact information request controller 206 transfers to the portable terminal 1 a request for points of contact connected to that contact name, through the intermediation of the contact information transmitter and receiver 202. Here, upon the receipt of a request for points of contact connected to the contact name “Mr. A”, for example, the portable terminal 1 transfers to the MFP 2 the points of contact, for example telephone number, facsimile number, and email address, connected to the contact name “Mr. A” and registered on the portable terminal 1 itself.

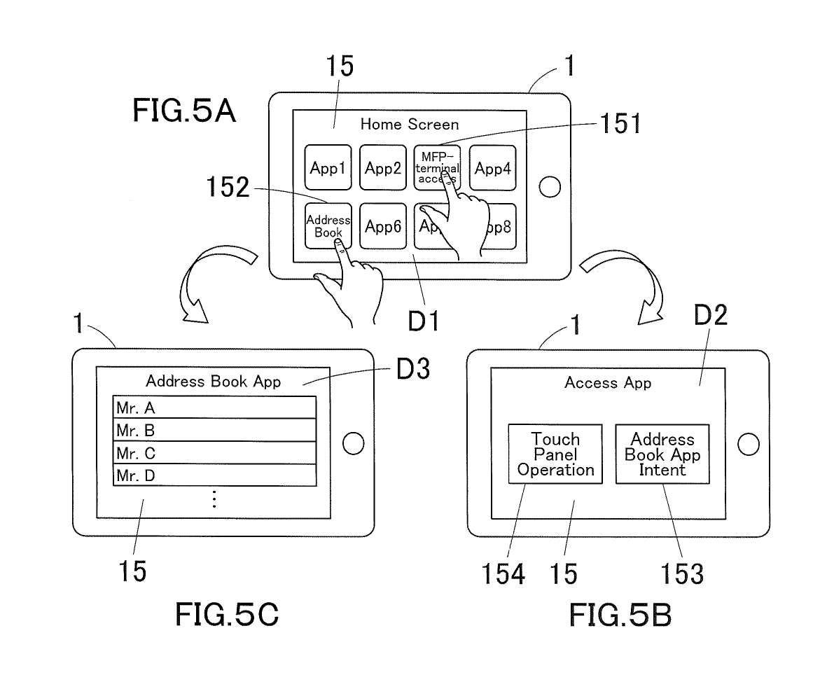

FIG. 5A illustrates a schematic view of a home screen D1 to be displayed on the display 15 of the portable terminal 1. Since the portable terminal 1 has an access app, a general-purpose address book app, and other apps being installed thereon, app icons 151 and 152 shown on the home screen D1 represent the access app and the address book app, respectively.

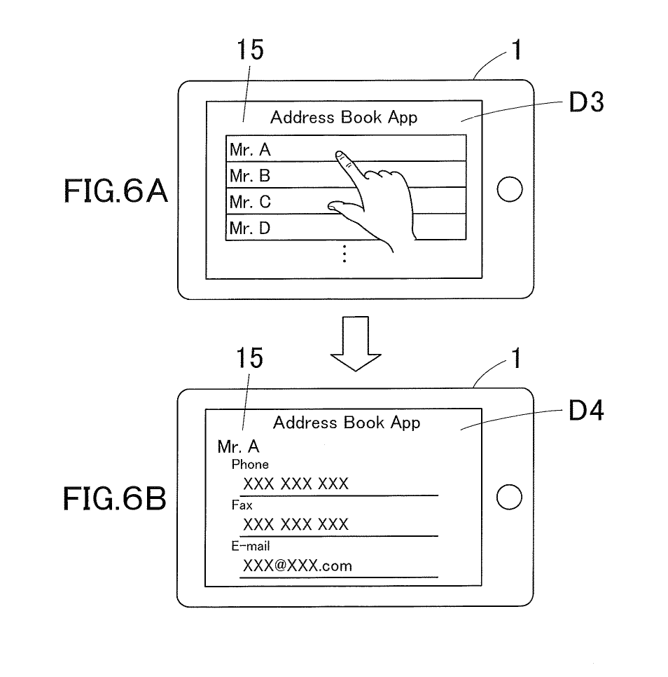

For example, when the user starts up the address book app on the home screen D1 by touching the app icon 152 representing the address book app, the screen switches to a screen D3 as illustrated in FIG. 5C on which a list of contact names is displayed on the basis of the contact information stored on the portable terminal 1. As illustrated in FIG. 6A, when the user selects a desirable contact name from the list on the screen D3, the screen switches to a screen D4 as illustrated in FIG. 6B on which points of contact connected to that contact name (telephone number, facsimile number, and email address, for example) are displayed. In this way the user can check this information on the portable terminal 1.

For another example, when the user starts up the address book app on the home screen D1 of FIG. 5A, by touching the app icon 151 representing the access app, access is enabled between the portable terminal 1 and the MFP 2 and the screen on the display 15 switches to a screen D2 as illustrated in FIG. 5B, which indicates that the access is now enabled. On the screen D2, there are a touch panel operation button 154 for manipulating the MFP 2 and an address book app intent button 153 for launching the address book app by intent.

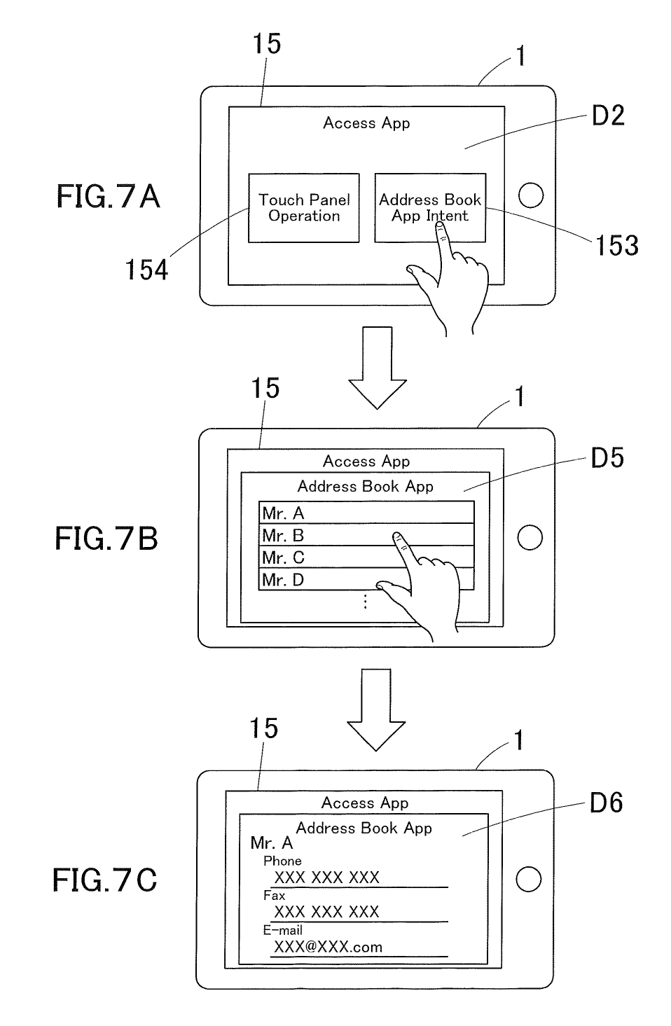

As illustrated in FIG. 7A, the user is allowed to start up the address book app from the access app on the screen D2 by touching the address book app intent button 153 (intent is enabled in this way). Specifically, when the user starts up the address book app from the access app, the screen switches to a screen D5 as illustrated in FIG. 7B on which a list of contact names is displayed, being similar to those on the screen D3 of FIG. 6. When the user further selects a desirable contact name from the list on the screen D5, the screen switches to a screen D6 as illustrated in FIG. 7C on which points of contact connected to that contact name are displayed.

Furthermore, the contact names and the points of contact displayed on the display 15 are automatically obtained and transferred to the MFP 2 by the access app.

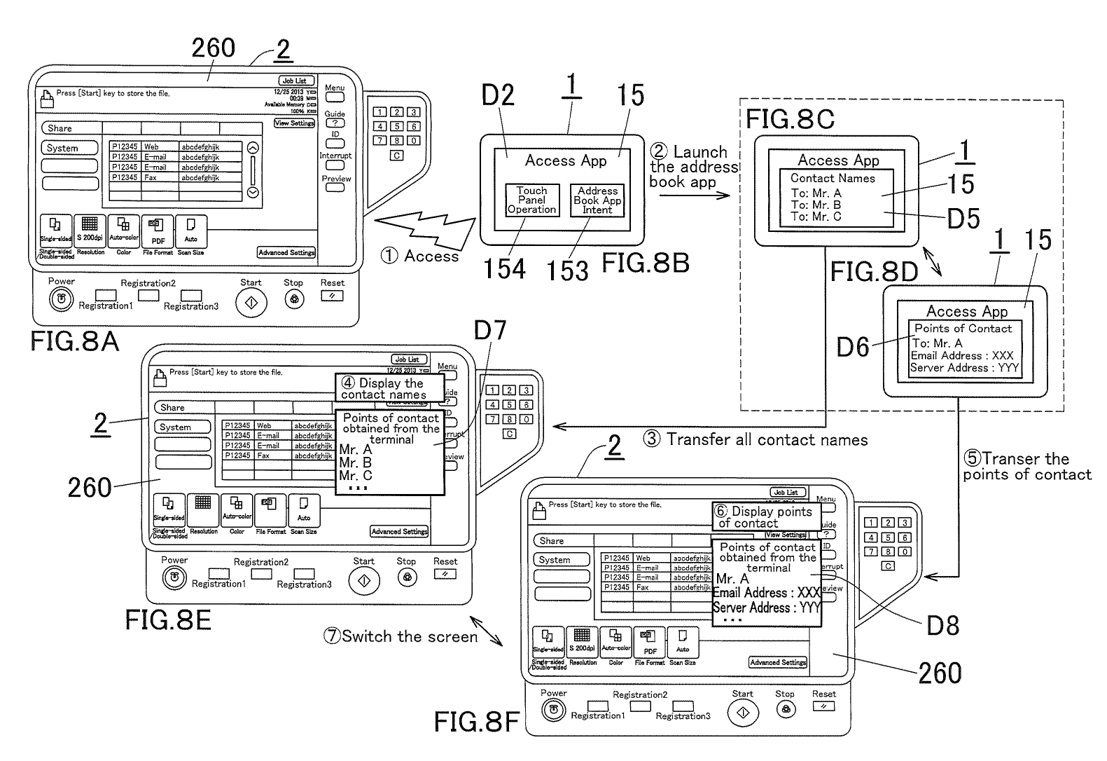

FIGS. 8A to 8F illustrate a contact information transfer process to be performed by the portable terminal 1 and the MFP 2 when intent is enabled.

When the user starts up the access app on the portable terminal 1, access is enabled between the portable terminal 1 and the MFP 2 (circled number 1 in FIG. 8) and the screen displayed on the display 15 of the portable terminal 1 is switched to the screen D2 of FIG. 8B on which the address book app intent button 153 and the touch panel operation button 154 are displayed. Meanwhile, FIG. 8A illustrates the screen displayed on the LCD panel 260 of the MFP 2, which does not switch even after the access is enabled between the portable terminal 1 and the MFP 2.

When the user starts up the address book app from the access app by touching the address book app intent button 153 on the screen D2 of the portable terminal 1 (circled number 2 in FIG. 8), the screen switches to the screen D5 of FIG. 8C on which a list of contact names is displayed. When the user further selects a desirable contact name from the list on the screen D5, the screen switches to the screen D6 of FIG. 8D on which points of contact connected to that contact name are displayed.

Furthermore, the access app of the portable terminal 1 obtains the contact information displayed on the display 15, from the address book app by intent. For example, the access app obtains all the contact names while these are displayed in a list form as illustrated in FIG. 8C. The access app then transfers all the contact names to the MFP 2 (circled number 3 in FIG. 8).

Upon the receipt of all the contact names, the MFP 2 converts them into a data format supported on the LCD panel 260 and displays a pop-up screen D7 listing all the contact names, on the screen presently displayed on the LCD panel 260, as illustrated in FIG. 8E (circled number 4 in FIG. 8).

For another example, the access app obtains points of contact connected to the contact name while these are displayed on the display 15 as illustrated in FIG. 8D. The access app then transfers these points of contact to the MFP 2 (circled number 5 in FIG. 8).

Upon the receipt of the points of contact, the MFP 2 converts them into a data format supported on the LCD panel 260 and displays a pop-up screen D8 showing the points of contact, on the screen presently displayed on the LCD panel 260, as illustrated in FIG. 8F (circled number 6 in FIG. 8).

As described above, in this embodiment, upon access being enabled between the portable terminal 1 and the MFP 2 by the user, contact information is automatically transferred to the MFP 2 from the portable terminal 1 and displayed on the LCD panel 260. Specifically, since the MFP 2 is allowed to display all contact names on the LCD panel 260 while the portable terminal 1 displays the same on the display 15 and to display points of contact on the LCD panel 260 while the portable terminal 1 displays the same on the display 15, contact information, i.e., all contact names and points of contact connected to a specified one of the contact names, is automatically transferred to the MFP 2 from the portable terminal 1 and displayed on the LCD panel 260, without the user being bothered by selecting a desirable contact name and giving transfer instructions on the portable terminal 1. Furthermore, the user does not have to keep switching his/her view on between the portable terminal 1 and the MFP 2 back and forth, achieving simple manipulation and a user-friendly system.

Furthermore, upon a contact name being selected by the user from those displayed on the LCD panel 260 of the MFP 2, a request for points of contact connected to the selected contact name is transferred to the portable terminal 1 from the MFP 2. In response to the request, points of contact connected to that contact name are obtained from the address book app then transferred to the MFP 2 as instructed by the access app of the portable terminal 1. Subsequently, the points of contact received therefrom are displayed on the LCD panel 260 of the MFP 2. This makes the system more user-friendly.

In this configuration, the MFP 2 also stores all the contact names, received from the portable terminal 1 and used for display, on a temporary memory area of the memory. The user may wish to return to the screen listing all the contact names from the screen showing the points of contact connected to the selected contact name, on the LCD panel 260. In such a case, this configuration allows the MFP 2 to switch its screen to the screen listing all the contact names from the screen showing the points of contact, by retrieving all the contact names from the memory area. In other words, this configuration allows the MFP 2 to switch to the screen listing all the contact names quickly, without the need of obtaining all the contact names from the portable terminal 1 again.

In this configuration, the MFP 2 may also store the points of contact, received from the portable terminal 1, on the temporary memory area of the memory in order to switch to the screen showing the points of contact from the screen listing all the contact names, by retrieving the points of contact from the memory area.

FIG. 9 illustrates a procedure of how the access app launches the address book app to obtain contact information.

To start with, the user starts up an access app 300 to display the screen D2. When the user touches the address book app intent button 153 on the screen D2, the access app 300 creates a “display contact information” intent and an “obtain contact information” intent to give them to the OS 105.

Receiving the “display contact information” intent, the OS 105 transfers it to an address book app 400 (if there is more than one address book app 400, the user can select a desirable one) that is capable of displaying contact information on the display 15.

The intent received from the OS 105 launches the address book app 400; the address book app 400 then obtains contact information organized by the address book app 400 itself, from the OS 105, and displays it on the display 15. Receiving the “obtain contact information” intent, the OS 105 obtains contact information from the memory area to give it to the access app 300.

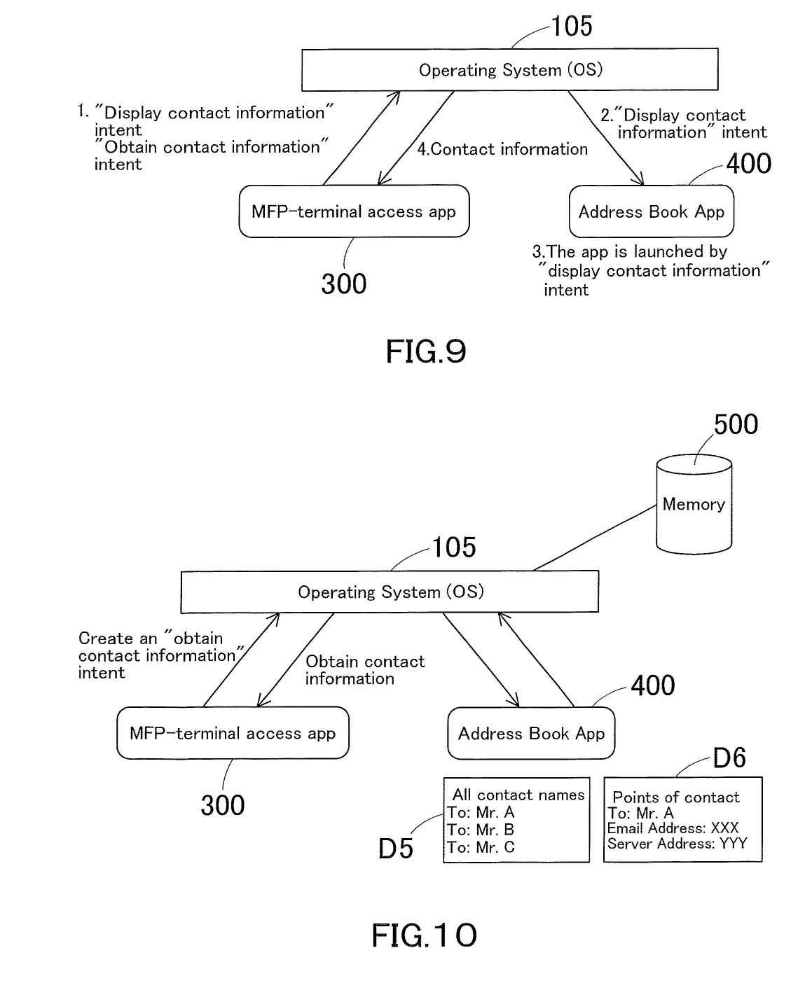

FIG. 10 illustrates a detailed procedure of how the access app 300 obtains contact information from the OS 105.

The access app 300 creates an “obtain contact information” intent for obtaining contact information from the OS 105. The address book app 400 obtains contact information from the OS 105 to display either the screen D5 listing all contact names or the screen D6 showing points of contact connected to a specified one of the contact names, on the display 15.

Receiving the “obtain contact information” intent, the OS 105 obtains contact information identical with that presently displayed by the address book app 400, from a memory 500 that is controlled by the OS 105 itself. The OS 105 then transfers the contact information to the access app 300 that is the creator of the “obtain contact information” intent. In this way, the access app 300 finally obtains the contact information from the OS 105. As described above, the access app 300 obtains contact information that is identical with that presently used by the address book app 400, by requesting the OS 105.

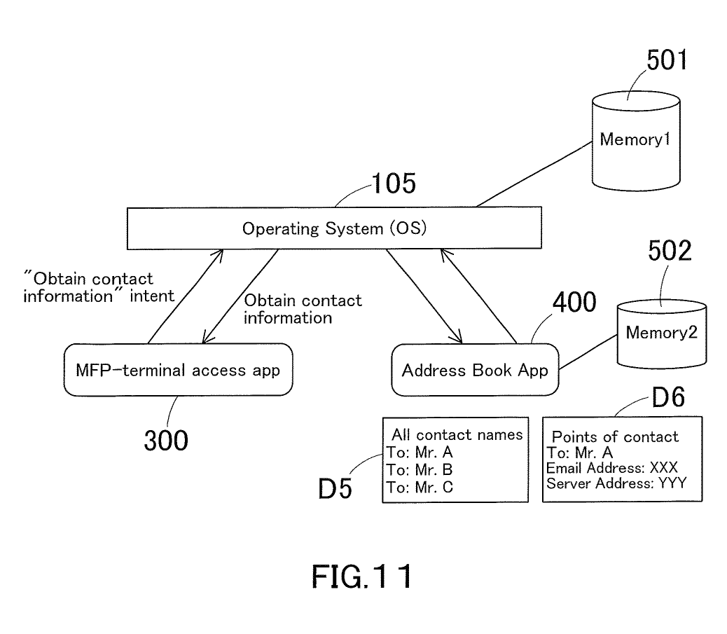

FIG. 11 illustrates another procedure of how the access app 300 obtains contact information. In this example, there are a first memory 501 controlled by the OS 105 and a second memory 502 that is a dedicated local memory controlled by the address book app 400. Contact information is stored on the second memory 502.

To start with, the access app 300 creates an “obtain contact information” intent for obtaining contact information from the OS 105. The address book app 400 obtains contact information from the second memory 502 to display either the screen D5 listing all contact names or the screen D6 showing points of contact connected to a specified one of the contact names, on the display 15.

Receiving the “obtain contact information” intent, the OS 105 obtains contact information identical with that presently displayed by the address book app 400, from the second memory 502 that is locally controlled by the address book app 400. The OS 105 then transfers the contact information to the access app 300. In this way, the access app 300 finally obtains the contact information from the OS 105.

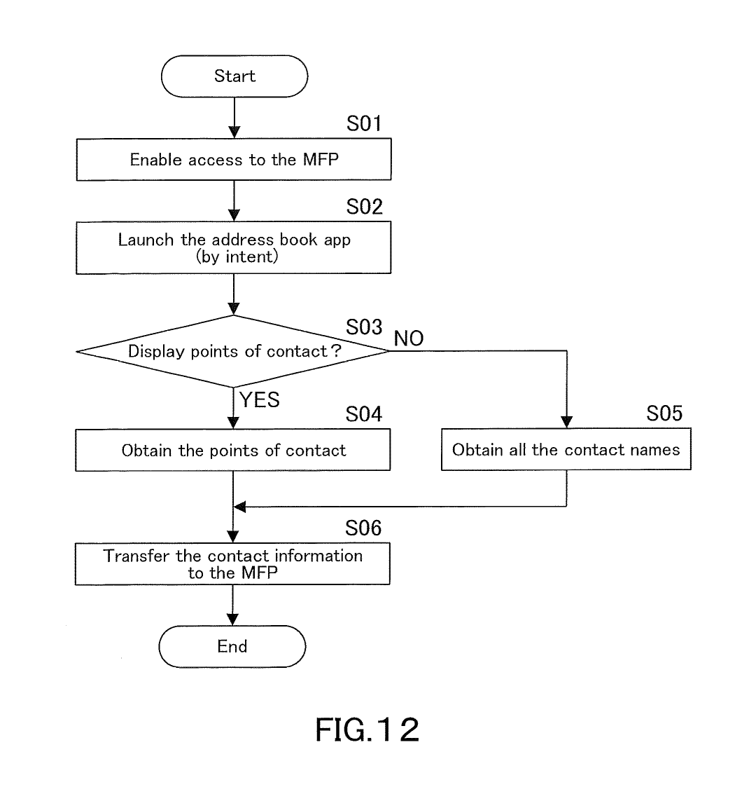

FIG. 12 is a flowchart representing an operation procedure of the portable terminal 1. The operation procedure is executed by the CPU 11 of the portable terminal 1 as instructed by the access app 300 and the OS 105.

The user starts up the access app 300; access to the MFP 2 is then enabled in Step S01. The address book app 400 is launched by intent in Step S02.

In Step S03, it is judged whether or not points of contact connected to a specified contact name is displayed on the display 15. If points of contact connected to a specified contact name is displayed thereon (YES in Step S03), these points of contact are obtained in Step S04. The routine then proceeds to Step S06. If points of contact connected to a specified contact name is not displayed thereon, i.e., if all contact names are displayed in a list form thereon (NO in Step S03), all the contact names are obtained in Step S05. The routine then proceeds to Step S06.

In Step S06, the contact information obtained, the points of contact or all the contact names, is transferred to the MFP 2 in packets.

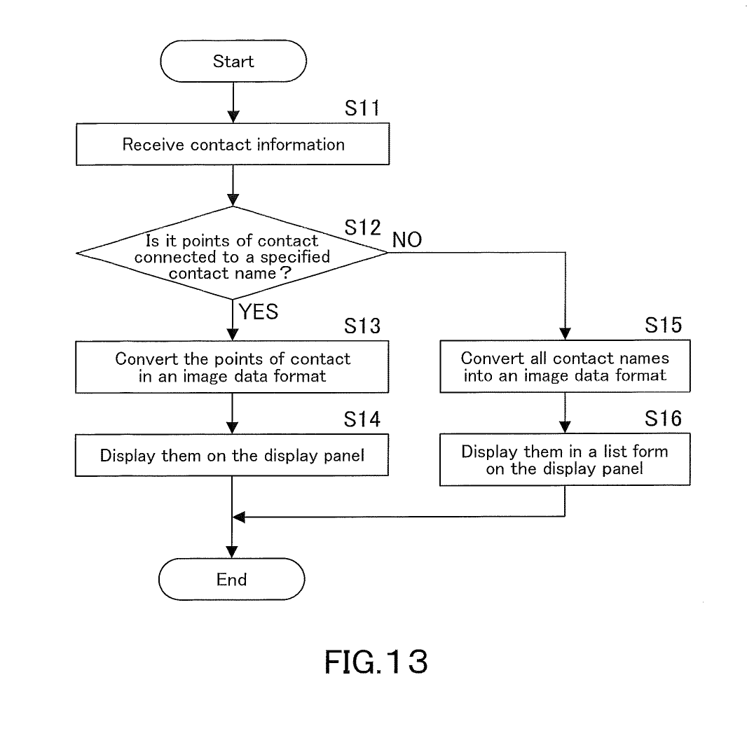

FIG. 13 is a flowchart representing an operation procedure of the MFP 2. In Step S11, contact information is received from the portable terminal 1. In Step S12, it is judged whether or not the contact information received is points of contact connected to a specified contact name. If it is points of contact connected to a specified contact name (YES in Step S12), the points of contact are converted into a data format supported on the LCD panel 260 in Step S13. After the conversion, in Step S14, the points of contact are displayed on the LCD panel 260.

Back to Step S12, if the contact information received is not points of contact connected to a specified contact name, i.e., if it is all contact names (NO in Step S12), all the contact names are converted into a data format supported on the LCD panel 260 in Step S15. After the conversion, in Step S16, all the contact names are displayed in a list form on the LCD panel 260.

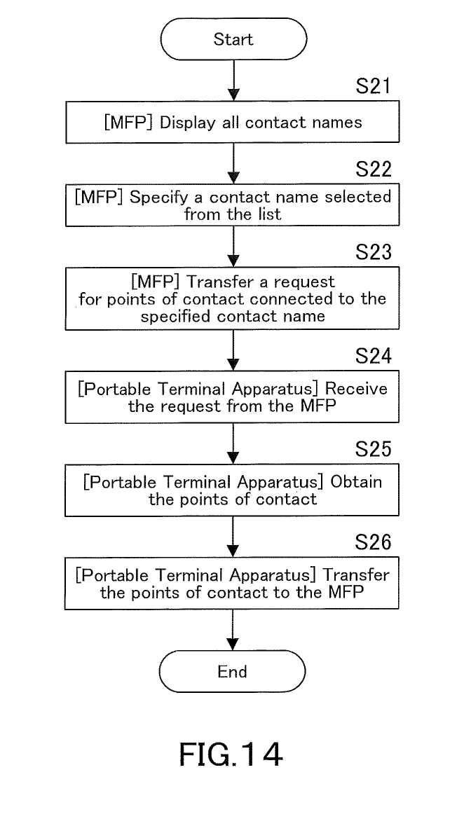

FIG. 14 is a flowchart representing an operation procedure to be executed by the MFP 2 and the portable terminal 1 when a user selects a contact name from those displayed in a list form on the LCD panel 260 of the MFP 2. In the flowchart of FIG. 14, the MFP 2 is in charge of the steps with the name “MFP” and the portable terminal 1 is in charge of the steps with the name “portable terminal”.

In Step S21, the MFP 2 displays all contact names on the LCD panel 260. The user selects a contact name from the list and the MFP 2 specifies this contact name in Step S22. In Step S23, the MFP 2 transfers to the portable terminal 1 a request for points of contact connected to that contact name.

The portable terminal 1 receives a request for the points of contact from the MFP 2 in Step S24 and obtains the points of contact in Step S25. Subsequently, in Step S26, the portable terminal 1 transfers the obtained points of contact to the MFP 2. The MFP 2 displays the points of contact received therefrom, on the LCD panel 260.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A contact information transfer system comprising an image processing apparatus and a portable terminal apparatus, the image processing apparatus and the portable terminal apparatus being capable of accessing each other, the portable terminal apparatus comprising:
a cooperation portion that launches a second application for organizing contact information upon access to the image processing apparatus being enabled by a first application for accessing the image processing apparatus, the contact information including a plurality of contact identification information for identifying the contact and points of contact, the points of contact being connected to the respective contact identification information;
a contact information obtaining portion that obtains the contact information as instructed by the first application, after the launch of the second application; and
a transfer portion that transfers the contact information to the image processing apparatus as instructed by the first application, the contact information being obtained by the contact information obtaining portion,
the image processing apparatus comprising:
a receiving portion that receives the contact information from the portable terminal apparatus;
a display; and
a display controller that displays the contact information on the display by converting the contact information into a data format supported on the display, the contact information being received by the receiving portion.

2. The contact information transfer system as recited in claim 1, wherein:
the portable terminal apparatus further comprises a display that displays the contact information and a judgment portion that judges whether a list of the contact identification information or a point of contact connected to a specified one of the contact identification information is displayed on the display of the portable terminal apparatus;
the portable terminal apparatus obtains all the contact identification information in the list and transfers them to the image processing apparatus if the judgment portion judges that the list of the contact identification information is displayed on the display of the portable terminal apparatus or the portable terminal apparatus obtains a point of contact connected to a specified one of the contact identification information and transfers it to the image processing apparatus if the judgment portion judges that the point of contact is displayed on the display of the portable terminal apparatus; and
the image processing apparatus displays all the contact identification information or the point of contact on the display of the image processing apparatus, the contact identification information or the point of contact being obtained therefrom.

3. The contact information transfer system as recited in claim 2, wherein:
the image processing apparatus further comprises:
a selection portion that specifies a contact identification information, the contact identification name being selected by a user among all the contact identification information displayed on the display of the image processing apparatus; and
a request portion that requests the portable terminal apparatus to provide a point of contact connected to the contact identification name, the contact identification name being specified by the selection portion;
the portable terminal apparatus obtains the point of contact and transfers it to the image processing apparatus as requested by the request portion; and
the image processing apparatus displays the point of contact on the display of the image processing apparatus, the point of contact being received from the portable terminal apparatus.

4. The contact information transfer system as recited in claim 3, wherein:
the image processing apparatus further comprises a storage portion that stores all the contact identification information and the point of contact both being received from the portable terminal apparatus; and
the display controller of the image processing apparatus makes the display of the image processing apparatus switch its screen between all the contact identification information and the point of contact by retrieving all the contact identification information and the point of contact from the storage portion.

5. A contact information transfer method to be implemented by a contact information transfer system comprising an image processing apparatus and a portable terminal apparatus, the image processing apparatus and the portable terminal apparatus being capable of accessing each other, the contact information transfer method comprising the steps of the portable terminal apparatus:
launching a second application for organizing contact information upon access to the image processing apparatus being enabled by a first application for accessing the image processing apparatus, the contact information including a plurality of contact identification information for identifying the contact and points of contact, the points of contact being connected to the respective contact identification information;
obtaining the contact information as instructed by the first application, after the launch of the second application; and
transferring the contact information to the image processing apparatus as instructed by the first application, the contact information being obtained also as instructed by the first application,
the contact information transfer method further comprising the steps of the image processing apparatus:
receiving the contact information from the portable terminal apparatus; and
displaying the contact information on the display by converting the contact information into a data format supported on the display, the contact information being received from the portable terminal apparatus.

6. A portable terminal apparatus comprising:
a cooperation portion that launches a second application for organizing contact information upon access to the image processing apparatus being enabled by a first application for accessing the image processing apparatus, the contact information including a plurality of contact identification information for identifying the contact and points of contact, the points of contact being connected to the respective contact identification information;
a contact information obtaining portion that obtains the contact information as instructed by the first application, after the launch of the second application; and
a transfer portion that transfers the contact information to the image processing apparatus as instructed by the first application, the contact information being obtained by the contact information obtaining portion.

7. The portable terminal apparatus as recited in claim 6, further comprising:
a display that displays the contact information; and
a judgment portion that judges whether a list of the contact identification information or a point of contact connected to a specified one of the contact identification information is displayed on the display,
wherein the contact information obtaining portion obtains all the contact identification information in the list if the judgment portion judges that the list of the contact identification information is displayed on the display or the contact information obtaining portion obtains a point of contact connected to a specified one of the contact identification information if the judgment portion judges that the point of contact is displayed on the display.

8. The portable terminal apparatus as recited in claim 7, further comprising a receiving portion that receives a request for a point of contact connected to a specified one of the contact identification information, the request being given by the image processing apparatus after the contact information obtaining portion obtains all the contact identification information and the transfer portion transfers all the contact identification information to the image processing apparatus, wherein, in response to the request being received by the receiving portion, the contact information obtaining portion obtains the point of contact from the second application and the transfer portion transfers the obtained point of contact to the image processing apparatus.

9. A non-transitory computer-readable recording medium storing a contact information transfer program for a computer of a portable terminal apparatus, the contact information transfer program making the computer execute:
launching a second application for organizing contact information upon access to an image processing apparatus being enabled by a first application for accessing the image processing apparatus, the contact information including a plurality of contact identification information for identifying the contact and points of contact, the points of contact being connected to the respective contact identification information;
obtaining the contact information as instructed by the first application, after the launch of the second application; and
transferring the contact information to the image processing apparatus as instructed by the first application, the contact information being obtained also as instructed by the first application.

10. The non-transitory computer-readable recording medium as recited in claim 9, the portable terminal apparatus further comprising a display that displays the contact information, the contact information transfer program to execute:
judging whether a list of the contact identification information or a point of contact connected to a specified one of the contact identification information is displayed on the display; and
obtaining all the contact identification information in the list if it is judged that the list of the contact identification information is displayed on the display or obtaining a point of contact connected to a specified one of the contact identification information if it is judged that the point of contact is displayed on the display.

11. The non-transitory computer-readable recording medium as recited in claim 10, the contact information transfer program to further execute:
receiving a request for a point of contact connected to a specified one of the contact identification information, the request being given by the image processing apparatus after all the contact identification information are obtained and transferred to the image processing apparatus; and
obtaining the point of contact from the second application and transferring the obtained point of contact to the image processing apparatus, in response to the request being received.
